(19) United States
(12) Patent Application Publication
(10) Pub. No.: US 2003/0212962 A1
(43) Pub. Date: Nov. 13, 2003

(54) Thin client-server architecture for automated machine translation

(75) Inventors: Jeffrey J. Chin, Sugar Land, TX (US); Rina Horiuchi, Old Greenwich, CT (US); Kevin Akira Lee, Cerritos, CA (US); David Lowsky, San Francisco, CA (US); Joshua D. Schroeder, San Francisco, CA (US); Christopher S. Hong, Potomac, MD (US)

Correspondence Address: BINGHAM, MCCUTCHEN LLP, THREE EMBARCADERO, SUITE 1800, SAN FRANCISCO, CA, 94111-4067, US

(73) Assignee: Amikai, Inc.

(21) Appl. No.: 10/142,362

(22) Filed: May 8, 2002

(51) Int. Cl. G06F 17/24; G06F 17/21

(52) U.S. Cl. 715/536

(57) ABSTRACT

A system and method for machine translation are provided by a client computer program executable on the user's computer and an ASP-based service that performs translations on one or more servers on a subscription basis. The client computer program interfaces with word processing, spreadsheet, presentation, or other software to allow direct translation of structured documents. When the translation request is initiated, the document is parsed to separate the text from the document's structural information, and the text to translate is transmitted across a distributed computer network to a server where the translation occurs. The translation result is returned across the distributed computer network to the client computer program. The client computer program then restores the rich structure of the original document to the translated result, as desired by the user.

### BACKGROUND OF THE INVENTION

1. Field of the Invention

The present invention relates generally to computer systems and, particularly, to automated translation systems.

2. Related Art

Current on-line translation services typically provide translation services to web users. Users would visit a website that features a text box or translated chatroom and enter the text to translate. A mouse click or carriage-return triggers a request to a remote translation server that, in turn, receives the text to be translated and returns translated results back to the web server. The user is thus able to see the translated result displayed on a web page.

While convenient, such on-line translation services have a number of shortcomings. First, these on-line translation services are based purely on text translation, but are typically unable to process complexly formatted documents.

Most documents, however, are not simple text documents, but rather are richly structured files that are created for word processing, spreadsheet, presentation, and other software. Examples of such structure include: specific text font, font size, font color, or text highlighting; bolded, underlined, or italicized text, paragraph spacing, indenting, alignment, or justification information, bulleted or numbered items, multiple columns, borders, diagrams, tables, embedded images, equations, and animations.

In order to translate such files using current on-line translation services, the user is required to cut and paste individual text segments into a translation input area (typically, a text box on a web page), and then cut and paste the translation results back into the appropriate location in the document or into a new document. These multiple cut and paste steps are slow and inconvenient, and are impractical for documents of significant length. In addition, when the results are pasted back into a document, if the user wishes to have the structural information of the original source document retained, he or she must take care to recreate the document structure, a tedious, error-prone process.

Currently, to process structured documents, a user would have to purchase software that is loaded onto the user's computer. Such software packages may interface with word processing, spreadsheet, presentation, or other software packages to allow users to translate richly structured documents automatically, with individual text segments identified and translated, and the structure of the original document ported to the translated result text.

These software packages, however, have other significant drawbacks. These software packages, in fact, require a significant initial investment from the user. Furthermore, these software packages become outdated quickly, as the technology and the product advance. In addition, the translation services are limited to the computer on which the software is loaded. Also, once the software has been purchased, the user is not informed automatically of new versions, bug fixes, additional features, or additional language-pair translation capability for the translation software. The user is thus responsible for maintenance of the installed program. Finally, since the machine translation process is typically server-intensive, the availability of the user's computer is severely compromised during the translation process.

### SUMMARY OF THE INVENTION

The system and method of the present invention overcome the limitation of prior art machine translation systems, by providing a client computer program on the user's computer and an ASP-based service that performs translations on one or more servers on a subscription basis. The client computer program interfaces with word processing, spreadsheet, presentation, or other software to allow direct translation of structured documents. When the translation request is initiated, the document is parsed to separate the text from the document's structural information, and the text to translate is transmitted across a distributed computer network to a server where the translation occurs. The translation result is returned across the distributed computer network to the client computer program. The client computer program then restores the rich structure of the original document to the translated result, as desired by the user.

As a result, richly structured documents are processed by the client computer program that interfaces directly with word processing, spreadsheet, presentation, or other software to extract the text segments automatically, and then restore the original rich structure to the translated documents.

Furthermore, the client computer program can be provided free of charge (or for a nominal fee) and the ASP-based service can be provided for monthly subscription fee, thereby substantially reducing the user's initial investment. Furthermore, new versions of the client computer program can be downloaded by the user at any time, and updates to the translation servers are made without any initiation or request from the user, therefore the user is able to access the most recent technology or version of the product. The client computer program can be downloaded any number of times at no expense to the user, and the remote translation servers can be accessed from any device that has a connection to the distributed computer network, therefore the user has access to the translation from any computer on the distributed computer network at no additional expense. In addition, the user is informed automatically of new product information, updates, and bug fixes. The client computer program is always available for download and reinstallation, and the remote machine translation servers are maintained by the ASP-service provider, therefore the user does not have the worry of maintaining the translation program. The processing performed by the client computer program is minimal and the intensive translation task is performed by the remote translation server, therefore the user's computer is freed up to execute other programs.

### BRIEF DESCRIPTION OF THE DRAWINGS

FIG. 1 is a block diagram illustrating the overall architecture of a computer system, in accordance with some illustrative embodiments of the invention.

FIG. 2 is a block diagram illustrating the architecture of a computer system for downloading the client computer program, in accordance with some illustrative embodiments of the invention.

FIG. 3 is a flow diagram describing the process of downloading the client computer program of FIG. 2.

FIG. 4 is a block diagram illustrating the architecture of a computer system through which a user signs-up for an account on a server-based machine translation service, in accordance with some illustrative embodiments of the invention.

FIG. 5 is a flow diagram describing the process through which a user signs-up for an account on the server-based machine translation service of FIG. 4.

FIG. 6 is a block diagram of the architecture of a computer system through which a user signs-in to use a server-based machine translation service, in accordance with some illustrative embodiments of the invention.

FIG. 7 is a flow diagram describing the process through which a user signs-in to use the server-based machine translation service of FIG. 6.

FIG. 8 is a block diagram of the architecture of a computer system through which a user performs a translation using a server-based machine translation service, in accordance with some illustrative embodiments of the invention.

FIG. 9 is a flow diagram describing the process through which a user performs a translation using the server-based machine translation service of FIG. 8.

FIG. 10 is a block diagram illustrating the overall architecture of a computer system in which a text adapter prepares text output from an application or device for safe transmission, in accordance with some illustrative embodiments of the invention.

FIG. 11 is a flow diagram of the process through which the text adapter of FIG. 10 prepares text output from an application or device for safe transmission.

FIG. 12 is a flow diagram of the process through which a text adapter prepares text input received by an application or device for proper processing by the application or device, in accordance with some illustrative embodiments of the invention.

FIG. 13 is a screenshot showing a destination translation window, in accordance with some illustrative embodiments of the invention.

FIG. 14 is a screenshot showing a translation job queue window, in accordance with some illustrative embodiments of the invention.

FIG. 15 is a screenshot showing how a user can choose the destination of the translation of an incoming email message, in accordance with some illustrative embodiments of the invention.

FIG. 16 is a screenshot showing how a user can select whether to display an original email alone or the original and translation together, in accordance with some illustrative embodiments of the invention.

FIG. 17 is a screenshot showing how a user can choose the destination of the translation of an outgoing email message, in accordance with some illustrative embodiments of the invention.

### DETAILED DESCRIPTION OF THE INVENTION

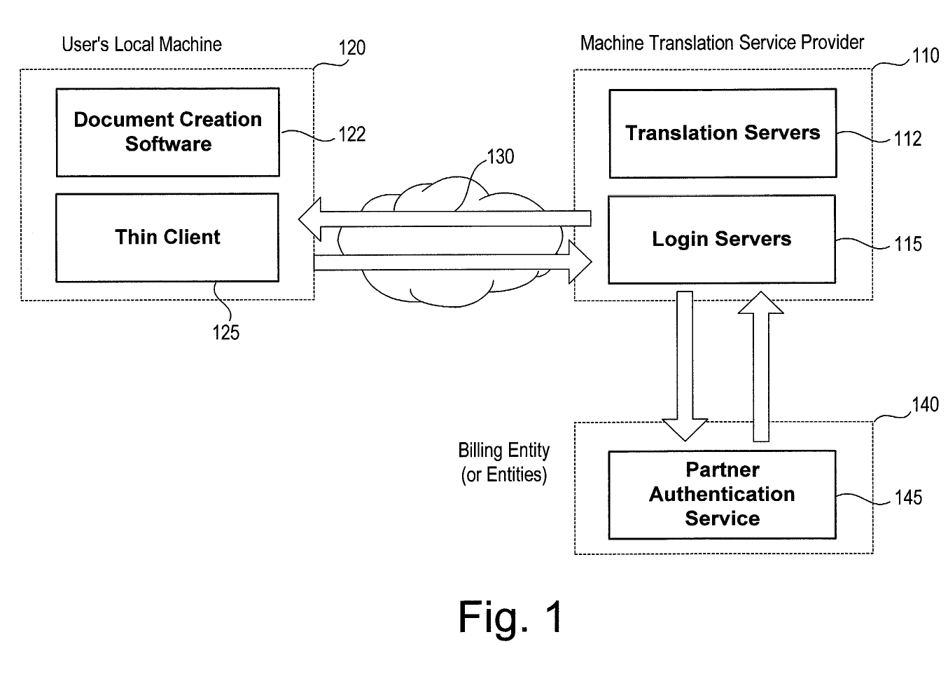

FIG. 1 is a block diagram of the overall architecture of a server-based machine translation service, in accordance with some illustrative embodiments of the invention. A server 110 is connected to one or more client computers 120 via a distributed network 130. On client computer 120 reside one or many document creation software applications 122 and a client computer program 125. In some embodiments of the invention, client computer program 125 is thin (i.e. it requires very little storage space), so that the client computer program 125 can be quickly downloaded onto client computer 120 over distributed computer network 130. Examples of document creation software applications 122 include word processing, email, spreadsheet, or slide presentation software. In some embodiments, client computer program 125 acts as a plug-in to one or more document creation software applications 122, to enable communication of translation requests with the machine translation service's servers 110. In some embodiments, however, client computer program 125 may also operate independently from document creation software applications 122.

Servers 110, in turn, contain machine translation servers 112 and log-in servers 115. Log-in servers 115 handle user account creation and sign-in authentication, communicating with Billing Services and with internal databases. Machine translation servers 112 process machine translation requests submitted by client computer programs 125 on users' client computers 120, and return the translated results to the requesting client computer program 125. Machine translation servers 112 can be any machine translation server known in the art, suitable for use in the present invention. A list of machine translation server providers in provided in Appendix A.

Billing services 145 are optionally internal to the server-based machine translation service provider (not shown), or are 3^{rd} party partners 140 (as shown in FIG. 1).

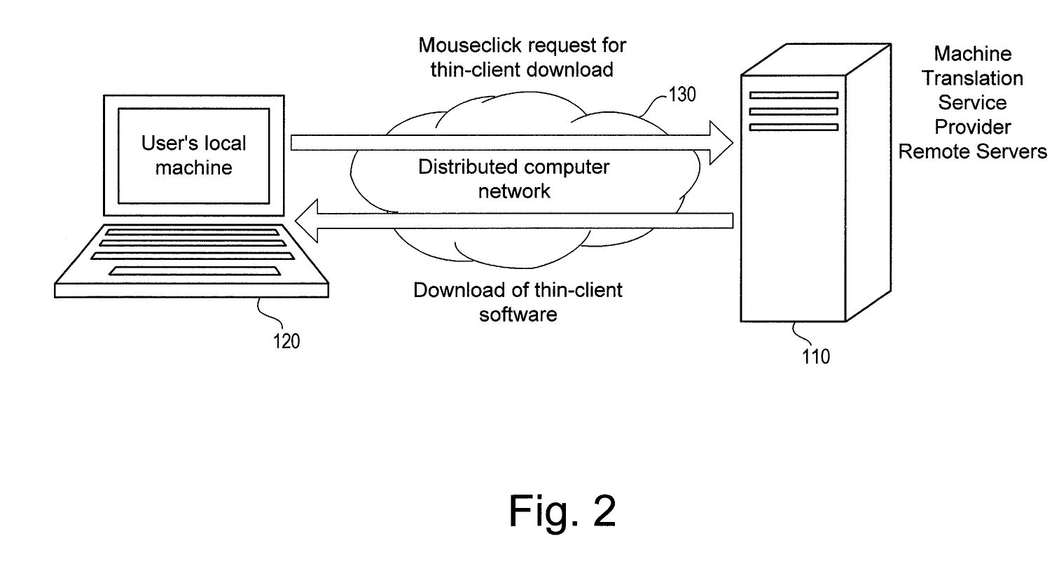

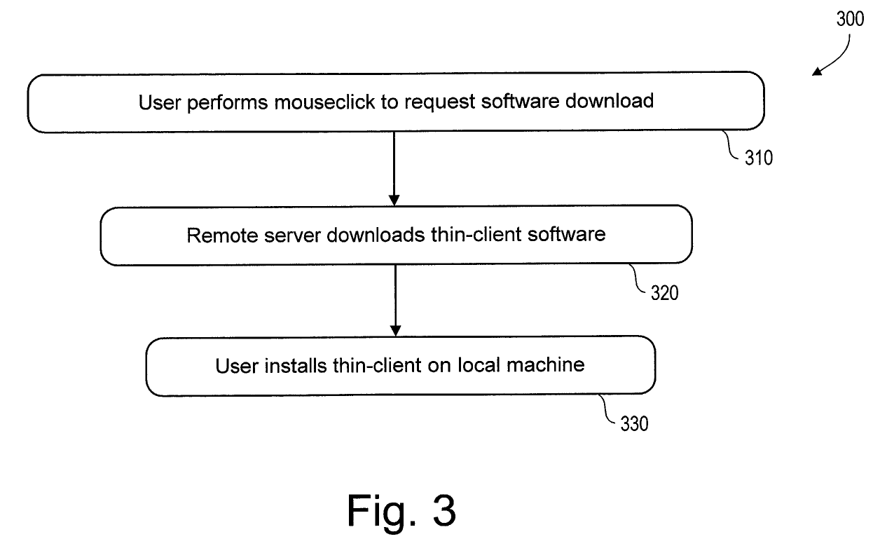

FIGS. 2 and 3 are block and flow diagrams describing a process 300 through which a user downloads the client computer program 125. Initially (stage 310), the user submits a request for client computer program 125 to be downloaded across distributed computer network 130 (e.g. the Internet). In some illustrative embodiments of the invention, this request could take the form of a mouse click in a web browser on a web page offering the client computer program download. Servers 110 receive the request, and immediately (stage 320) begin download of client computer program 125. Since client computer program 125 is provided for free (or for a nominal fee) to the user, there is no need to exchange billing or account information. Downloaded client computer program 125 is then installed on the user's client computer 120 (stage 330).

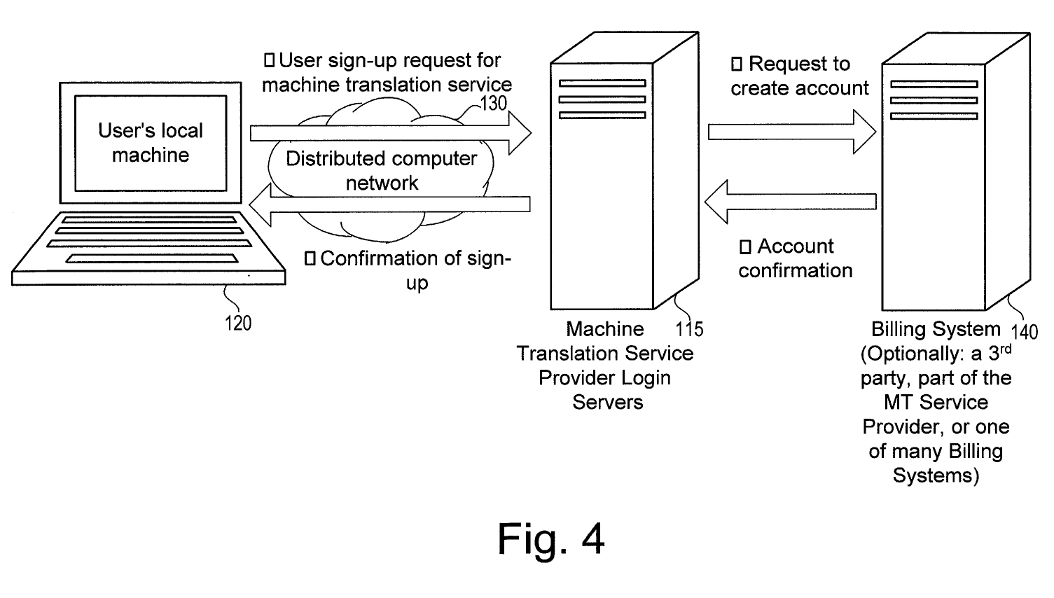

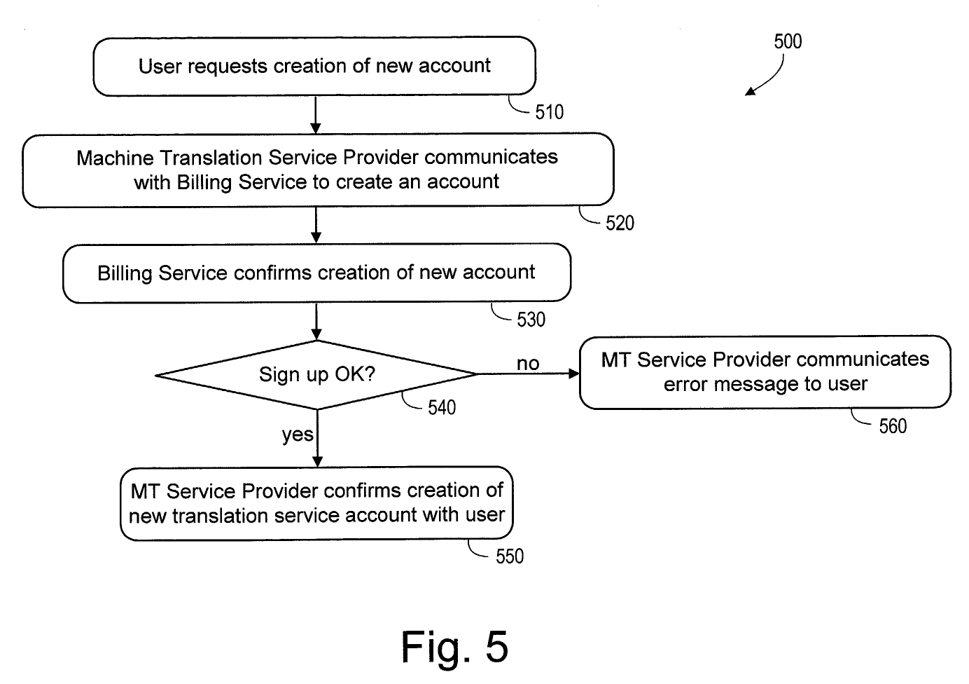

FIGS. 4 and 5 are block and flow diagrams describing a process 500 through which a user signs up for a server-based machine translation service, in accordance with some exemplary embodiments of the invention. Initially (stage 510) the user submits a request for account creation across distributed computer network 130. This request may involve a multi-part process including submission of information such as preferred account name, preferred account password, payment information, or other personal information. Login servers 115 transmit some or all of this information with billing service 140 (stage 520) to complete the account creation transaction (stage 530), including accepting payment and establishing the user account. If billing service 140 is able to create an account for the user (stage 540), login servers 115 are notified so that they may confirm the success of the account creation to the user's client computer 120 (stage 550). Conversely, if billing service 140 is unable to create an account for the user (stage 540), login servers 115 are notified so that they may inform the user through a error message to the user's client computer 120 (stage 560).

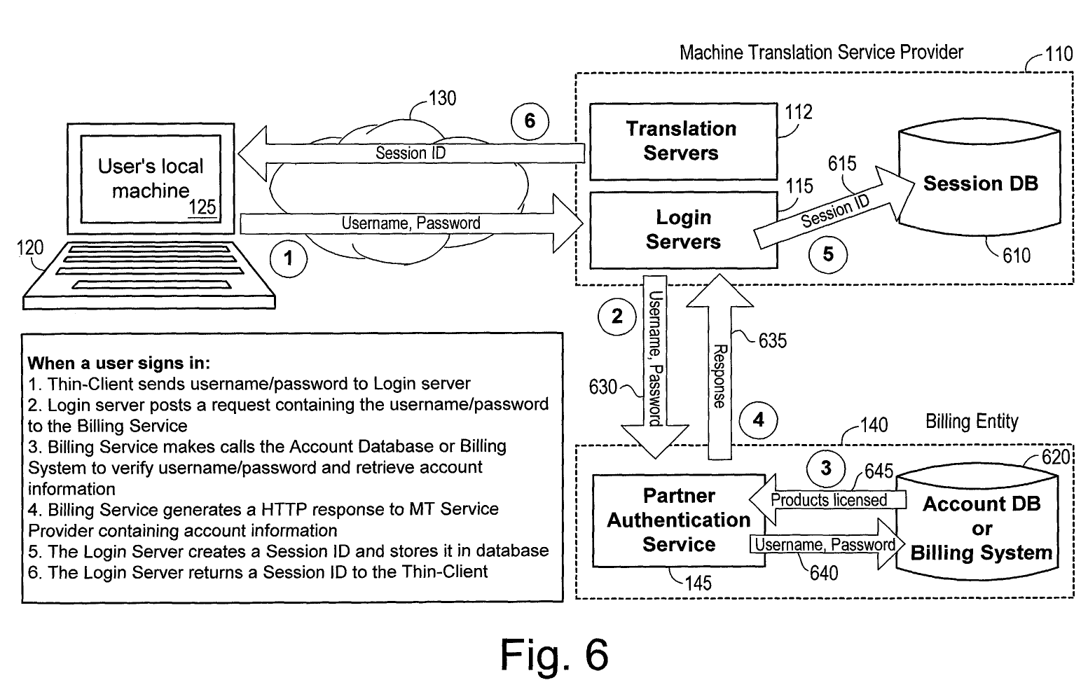

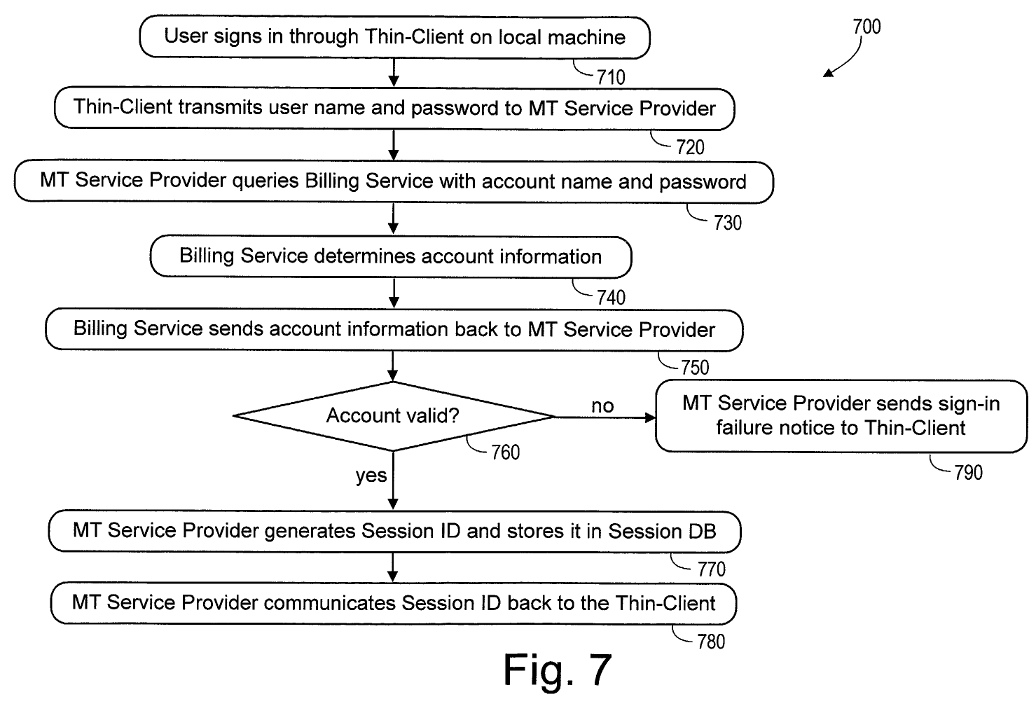

FIGS. 6 and 7 describe a process 700 through which a user signs-in to use the ASP-based Machine Translation Service, in accordance to some exemplary embodiments of the invention. The user initiates the sign-in process through the interface of the client computer program 125 on the user's client computer 120 (stage 710). Client computer program 125, in turn, transmits the user's account information (stage 720), such as account name and password across distributed computer network 130 to login servers 115 on servers 110. Login servers 115 then query billing service 140 with the user's account information 630 (stage 730). Billing service 140 authenticates the account information (stage 740) and communicates an account status 635 back to login servers 115 (stage 750). Billing service 140, in fact, uses partner authentication service 145 to query account database 620 with the user name and password 640 and obtain a response 645. If the account information is not valid (stage 760), login servers 115 communicate this error message back to the client computer program 125 on the user's client computer 120 (stage 790). Conversely, if the account information is valid (stage 760), login servers 115 are notified and a session ID 615 is generated (stage 770), stored in a session database 610, and then transmitted back to client computer program 125 on the user's client computer 120 where it is stored (stage 780).

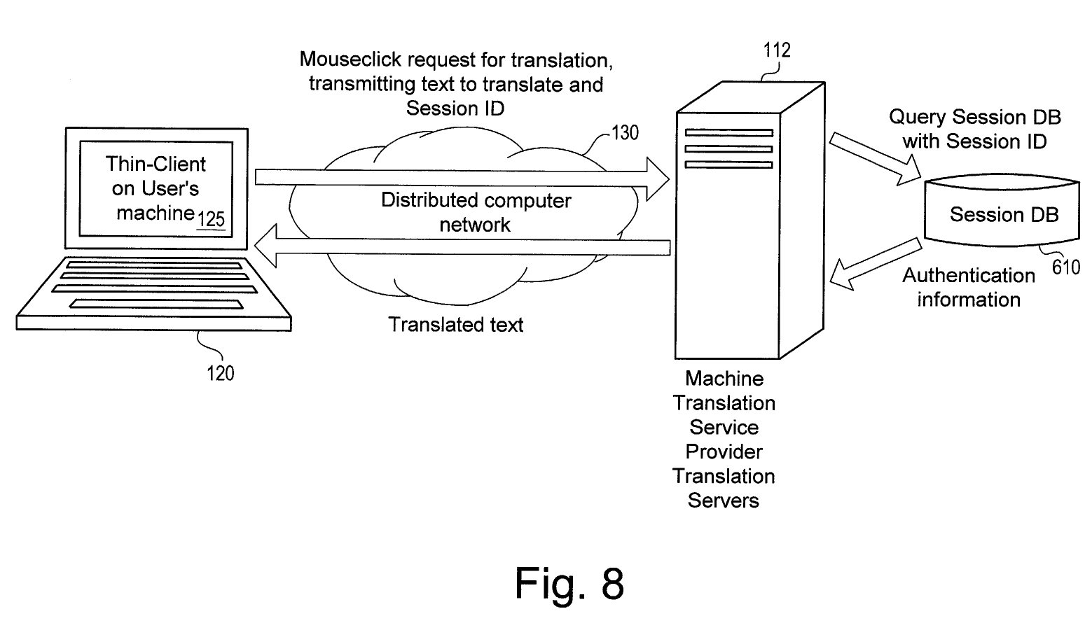

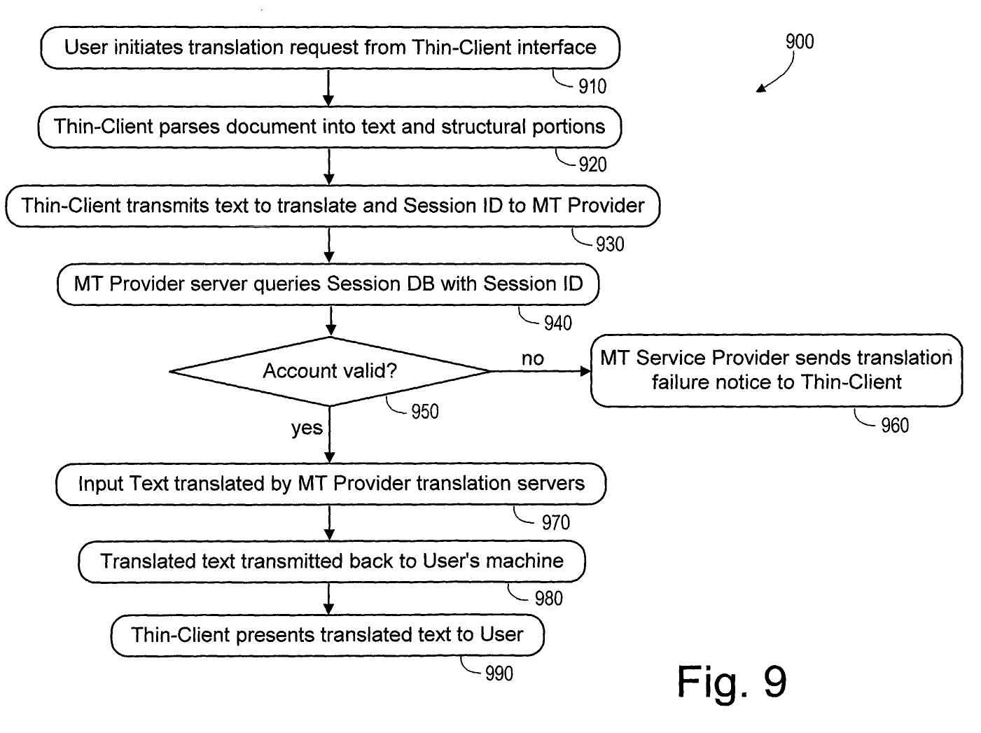

FIGS. 8 and 9 describe a process 900 through which a user submits a translation request to the server-based machine translation service, in accordance with some exemplary embodiments of the invention. The user initiates a translation request (stage 910) either through client computer program 125 running as a plug-in to a content creation software application 122 or through client computer program 125 itself. As discussed in reference to FIG. 1, document creation software 122 can be word processing, email, spreadsheet, slide presentation, or other document creation software. After the initiation of the translation request, client computer program 125 parses the text to translate from the document structure and saves the structural information about the document (stage 920). The plain-text is then communicated along with session ID 615 across distributed computer network 130 to the one or more translation servers 112 on servers 110 (stage 930). Session ID 615 is checked against the information stored in session DB 610 (stage 940). If session ID 615 is not valid (stage 950), the failure is reported back to the client computer program 125 on the user's client computer 120 (stage 960). Conversely, if session ID 615 is valid (stage 950), translation servers 122 translate the submitted text (stage 970), and return the translated output text to client computer program 125 on the user's client computer 120 (stage 980). Client computer program 125 then reassembles the translated text into the saved document structure to create a translated version of the original, richly-structured document (stage 990).

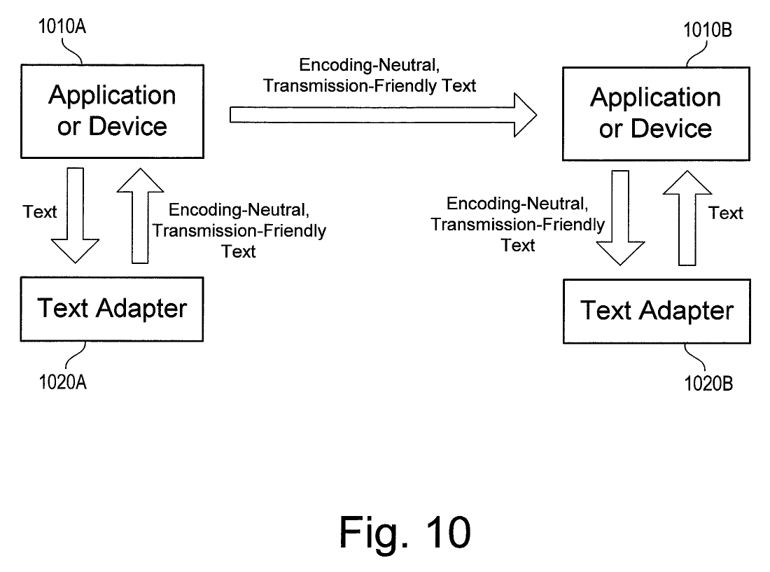

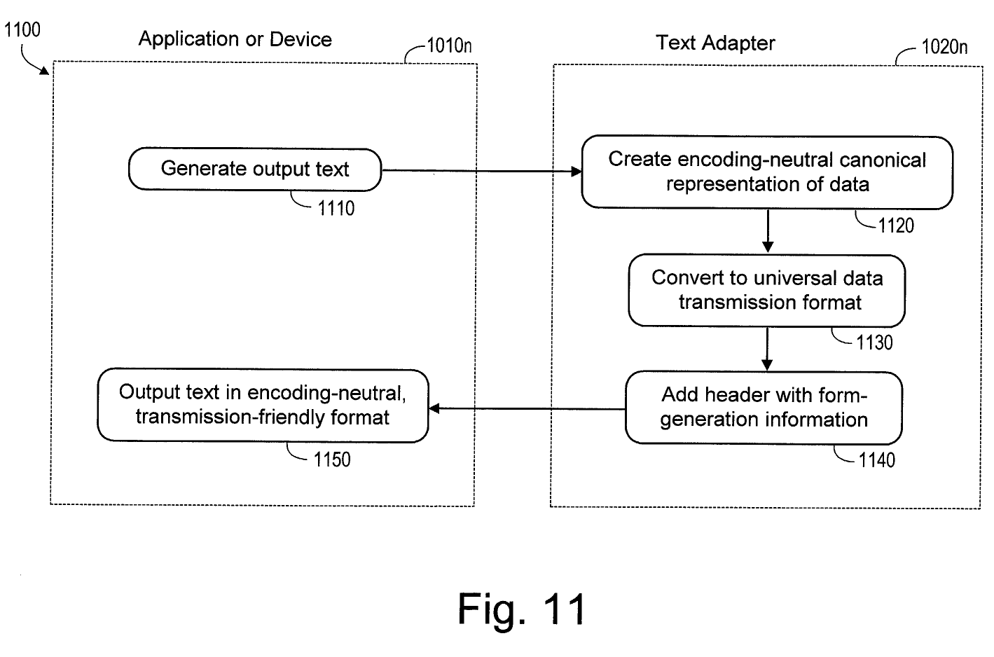

FIGS. 10 and 11 describe how client computer program 125 correctly handles and manipulates text data regardless of the limitations imposed by the operating system or by the document-creation software. This processing is necessary because computer systems and applications impose certain limitations on the types of text data which they are capable of handling. A machine translation system, however, must be prepared to handle many different character sets and provide text encoding flexibly. This is accomplished via specialized text data adapters 1020n (where n=A, B, C . . . ), which are used for all transmission (both synchronous and asynchronous) of text between applications 1010n and devices 1010n, applications 1010n and applications 1010n, and devices 1010n and devices 1010n. Text data adapters 1020n re-encode the text data in a platform-independent manner and transmit that re-encoded information as a protected canonical data type. FIG. 10 shows the overall architecture of this system.

FIG. 11 describes a process 1100 through which a text adapter 1020n prepares text output from an application 1010n or device 1010n for safe transmission, regardless of the encoding limitations of the operating system or receiving application or device. First, the transmitting application or device sends a request to text adapter 1020n (stage 1110), where the request consists of the original text data and the name or ID of the encoding used in the original text data. The request may also specify the canonical form convention that text adapter 1020n should use to generate the output data.

Text adapter 1020n creates an encoding-neutral canonical representation of the original text data (stage 1120) by first converting the text data to a base universal encoding, such as UTF-16 or any other base universal encoding. Then the encoding-neutral canonical representation is converted to a universal data transmission format (stage 1130), such as ASCII, using a general binary-to-transmission-format encoding scheme, such as base-64 encoding. This transmission-friendly form of the encoding-neutral representation is then prefixed with a header that indicates the form used to generate the data (stage 1140). The text adapter then returns this header-prefixed data to the transmitting application 1010n or device 1010n (stage 1150), which can then safely transmit then data.

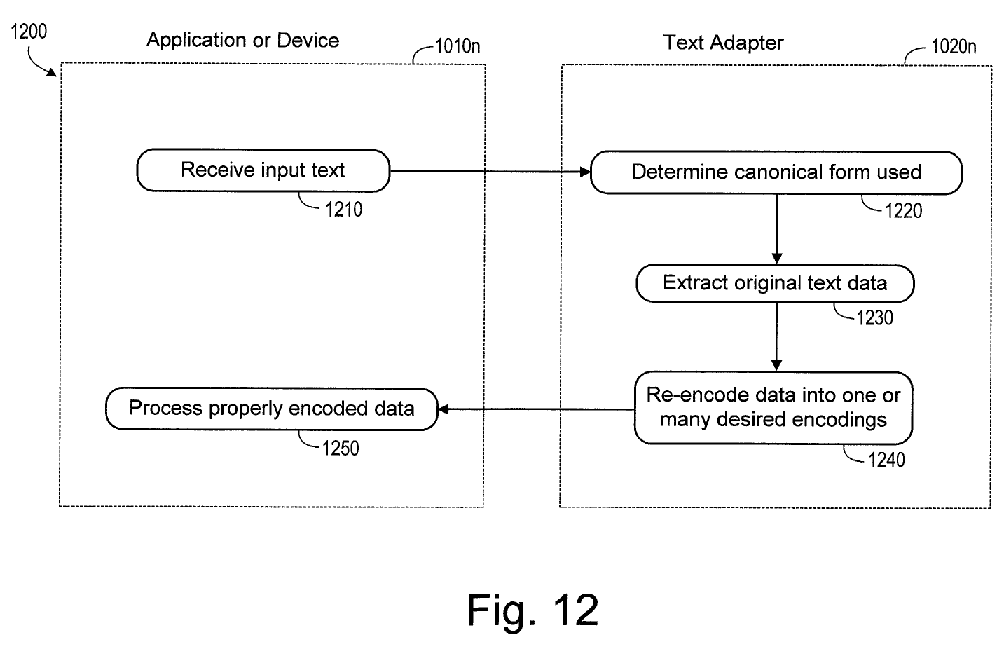

FIG. 12 describes a process 1200 through which a text adapter 1020n prepares text input received by an application 1010n or device 1010n for proper processing by the application 1010n or device 1010n, regardless of the encoding limitations of the operating system, application, or device, and without losing any information about the original text. First, the receiving application 1010n or device 1010n receives some text input in an encoding-neutral, transmission-friendly format (stage 1210). Application/device 1010n, in turn, sends a request to text adapter 1020n, where the request consists of the canonical representation of the text data and the one or many desired text character encoding for the text. Upon receipt, text adapter 1020n examines the canonical representation and determines the canonical form used (stage 1220). Text adapter 1020n then extracts the original text data (in the base universal text encoding) using that information (stage 1230). Text adapter 1020n, in turn, re-encodes the extracted text data into one of the target text encoding specified in the request and returns that re-encoded data to the host application (stage 1240). The re-encoded data can then be processed by application/device 1010n (stage 1250).

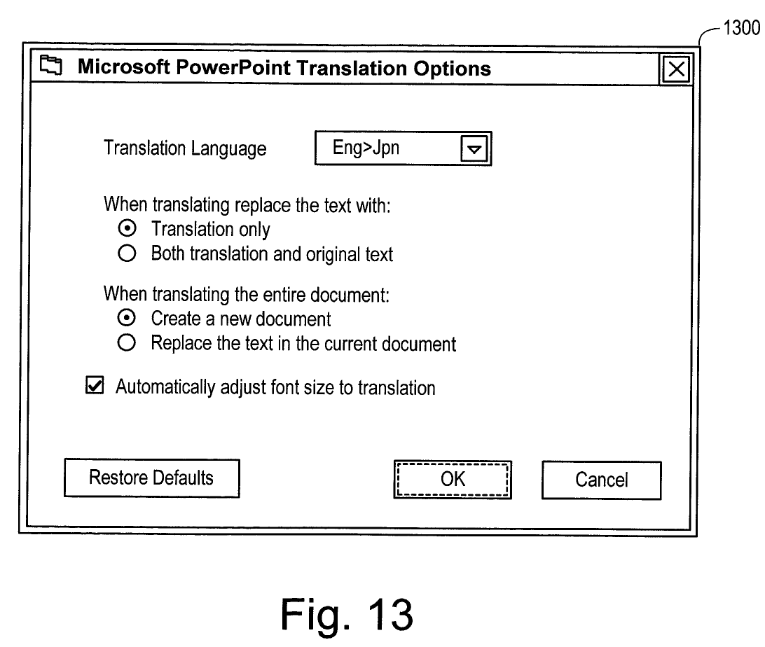

FIG. 13 is a screenshot of a translation destination window 1300, in accordance with some illustrative embodiments of the invention. By selecting options listed on translation destination window 1300, the user is able to select the destination of the translation result of a translation request. During the translation process, the user is queried for a translation destination, and the system sends the translation to the appropriate destination. Possible translation destinations include the end of the original source text document, the clipboard, a new document, or an attachment to a document.

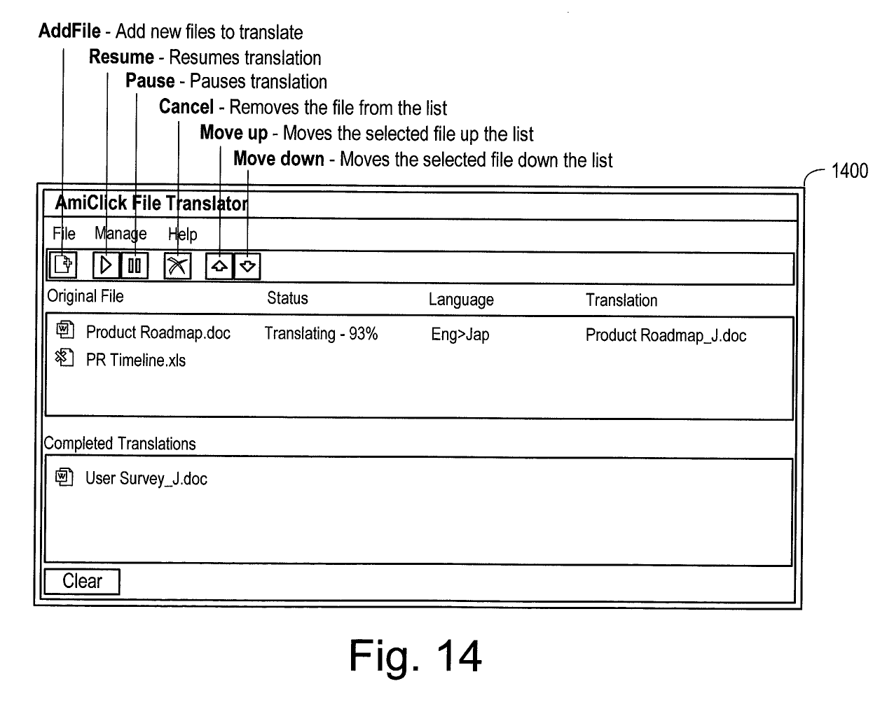

FIG. 14 is a screenshot of a translation job queue window 1400, in accordance with some illustrative embodiments of the invention. Translation job queue window 1400 shows the printing queue for a user using the translation service. When a translation request is made, the document enters the queue at an appropriate location. When the translation service is ready to service a request, it pulls a document from the queue from an appropriate location. When a document translation is completed, the document is either returned to the queue, marked as completed, or is returned to a separate list of completed translations. While a document is queued, the user can use the queue to raise or lower the priority of the document's translation. While a document is being translated, the user can use the queue to suspend the document's translation and reinsert the document into the queue. After a document translation has been completed, a user can use the queue or the completed translation list to request that the document be opened with an appropriate application.

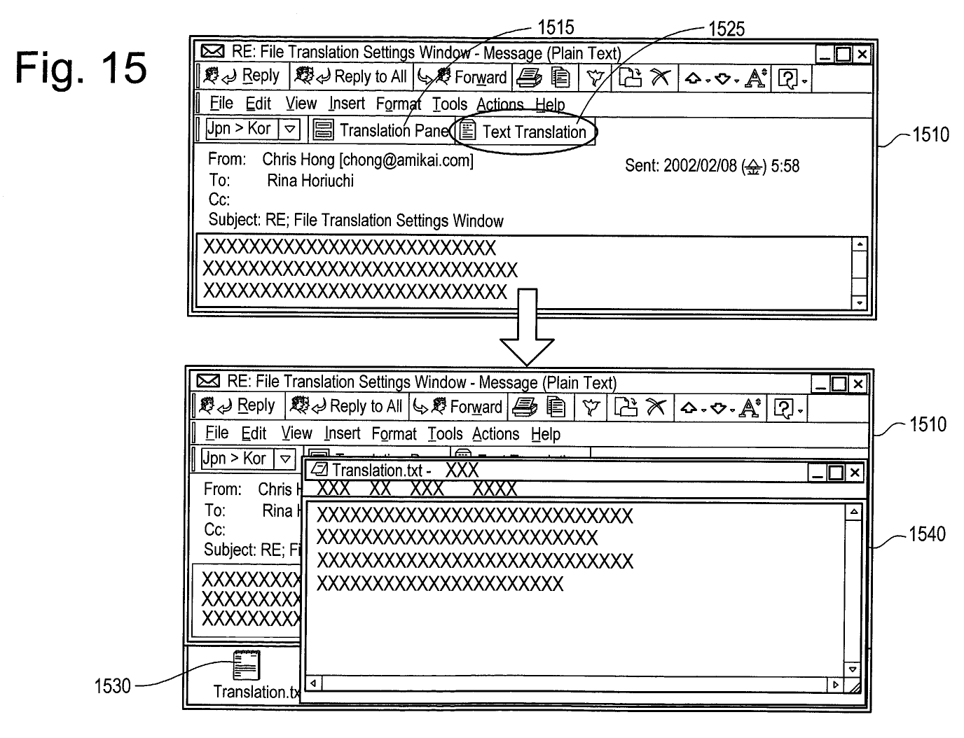

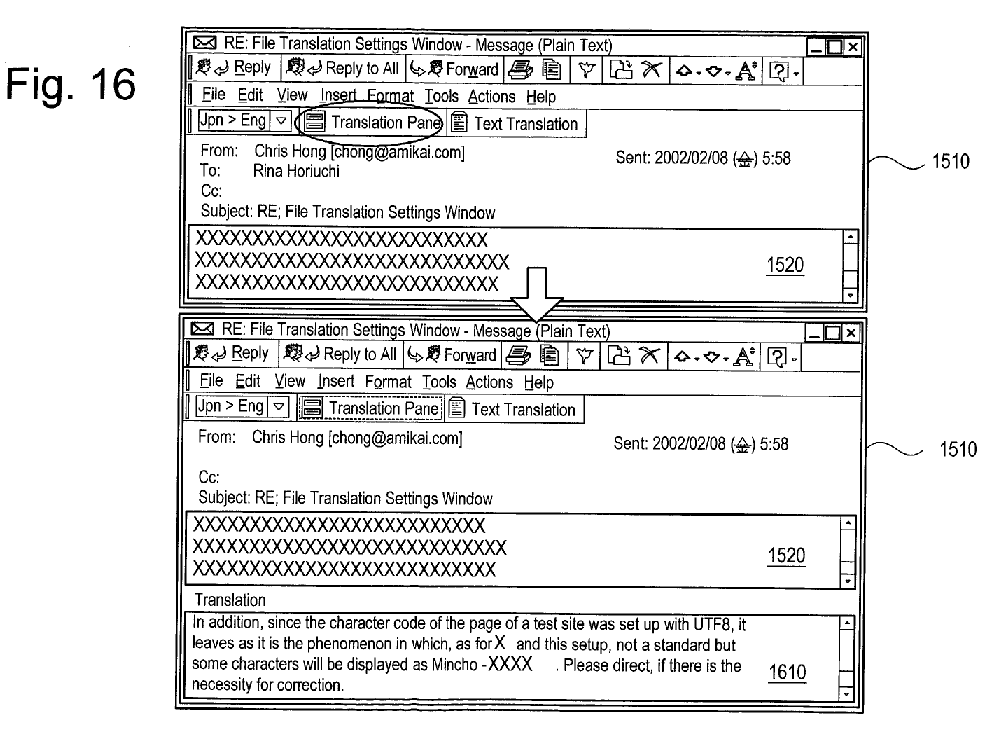

FIGS. 15-16 are screenshots illustrating elements of an email plug-in user interface for incoming messages, in accordance with some exemplary embodiments of the invention. In particular, FIG. 15 shows how the user can select the destination of the translation of an incoming email message via translation pane button 1515 and text translation button 1525. If the user selects text translation button (FIG. 15) the translation is stored as an attachment 1530 to the incoming message, which conveniently binds the original 1510 and translated versions 1540 of the email message. Conversely, FIG. 16 shows the user's ability to toggle the display between showing the original alone and the original with the translation by selecting translation pane button 1515. In some embodiments of the translation service, the user could also be allowed to display only the translation of the email message 1610.

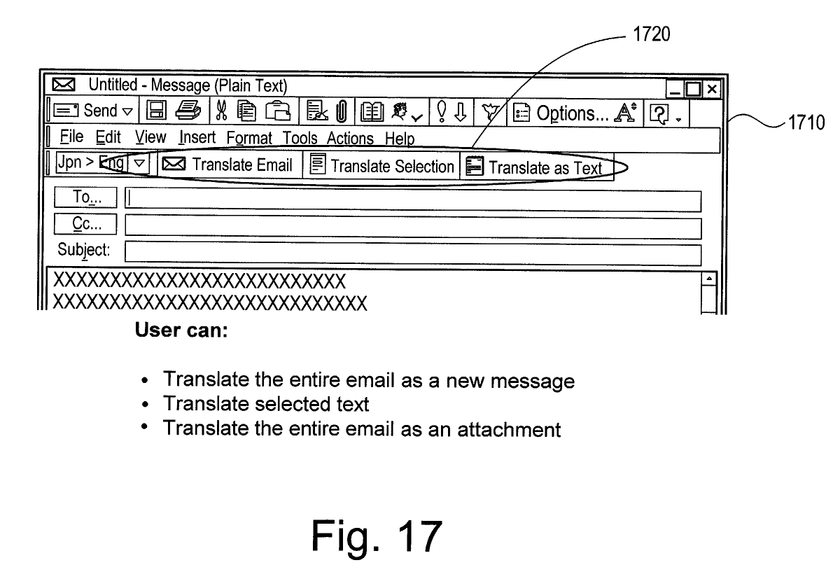

FIG. 17 shows the user's choices for the destination of the translation of an outgoing email message 1710. Exemplary translation destinations include a new email message, the end of the original message, or an attachment to the original message. The user is able to select among possible translation destination via buttons 1720.

Embodiments described above illustrate, but do not limit the invention. In particular, the invention is not limited to any specific hardware or software implementations. In fact, the system and method of the present invention can be implemented using any combination of hardware and/or software components, in accordance with the principles of the present invention. Other embodiments and varieties are within the scope of the invention, as defined by the following claims.

[image]

[image]

[image]

[image]

[image]

I claim:

1. A computer system comprising:
a server computer connected to one or more client computers via a distributed computer network; and
a server computer program executable by the server computer, the server computer program comprising computer instructions for:
receiving a request from one of the client computers to translate a content portion of a document;
translating the content portion of the document; and
sending the translated content portion of the document to the requesting client computer;
wherein a client computer program executable by the client computer further comprises computer instructions for:
parsing the document to generate the content portion and a structural portion;
sending the request to translate the content portion of the document to the server computer;
receiving the translated portion of the document from the server computer; and
merging the translated portion of the document and the structural portion of the document to generate a translated document.

2. The computer system of claim 1, wherein the distributed computer network is a global-area computer network.

3. The computer system of claim 2, wherein the global-area computer network is the Internet.

4. The computer system of claim 1, wherein the distributed computer network is a wide-area computer network.

5. The computer system of claim 1, wherein the distributed computer network is a local-area computer network.

6. The computer system of claim 1, wherein the request to translate the content portion of the document is sent over the distributed computer network.

7. The computer system of claim 1, wherein the translated content portion of the document is sent over the distributed computer network.

8. The computer system of claim 1, wherein the client computer program is a plug-in.

9. The computer system of claim 1, wherein the client computer program is downloaded onto the client computer over the distributed computer network.

10. The computer system of claim 9, wherein the client computer program downloaded onto the client computer is thin.

11. A method of performing machine translation, the method comprising:
parsing a document to generate a content portion and a structural portion;
sending a request to translate the content portion of the document to a server computer;
receiving a translated portion of the document from the server computer; and
merging the translated portion of the document and the structural portion of the document to generate a translated document.

12. The method of claim 11, wherein the request to translate the content portion of the document is sent over a distributed computer network.

13. The method of claim 12, wherein the distributed computer network is a global-area computer network.

14. The method of claim 13, wherein the global-area computer network is the Internet.

15. The method of claim 12, wherein the distributed computer network is a wide-area computer network.

16. The method of claim 12, wherein the distributed computer network is a local-area computer network.

17. The method of claim 11, wherein the translated content portion of the document is sent over the distributed computer network.

18. The method of claim 11, further comprising downloading a client computer program onto the client computer over a distributed computer network.

19. The method of claim 18, wherein the client computer program downloaded onto the client computer is thin.

20. The method of claim 18, wherein the client computer program is a plug-in.

21. A computer-readable storage medium storing a server computer program executable by a server computer connected to one or more client computers via a distributed computer network, the server computer program comprising computer instructions for:
receiving a request from one of the client computers to translate a content portion of a document;
translating the content portion of the document; and
sending the translated content portion of the document to the requesting client computer;
wherein a client computer program executable by the client computer further comprises computer instructions for:
parsing the document to generate the content portion and a structural portion;
sending the request to translate the content portion of the document to the server computer;
receiving the translated portion of the document from the server computer; and
merging the translated portion of the document and the structural portion of the document to generate a translated document.

22. The computer-readable storage medium of claim 21, wherein the distributed computer network is a global-area computer network.

23. The computer-readable storage medium of claim 22, wherein the global-area computer network is the Internet.

24. The computer-readable storage medium of claim 21, wherein the distributed computer network is a wide-area computer network.

25. The computer-readable storage medium of claim 21, wherein the distributed computer network is a local-area computer network.

26. The computer-readable storage medium of claim 21, wherein the request to translate the content portion of the document is sent over the distributed computer network.

27. The computer-readable storage medium of claim 21, wherein the translated content portion of the document is sent over the distributed computer network.

28. The computer-readable storage medium of claim 21, wherein the client computer program is a plug-in.

29. The computer-readable storage medium of claim 21, wherein the client computer program is downloaded onto the client computer over the distributed computer network.

30. The computer-readable storage medium of claim 29, wherein the client computer program downloaded onto the client computer is thin.
